(19) United States
(12) Patent Application Publication
(10) Pub. No.: US 2023/0386077 A1
(43) Pub. Date: Nov. 30, 2023

(54) POSITION ESTIMATION SYSTEM, POSITION ESTIMATION METHOD, AND COMPUTER PROGRAM

(71) Applicant: NEC Corporation, Minato-ku, Tokyo (JP)

(72) Inventor: Yusuke Morishita, Tokyo (JP)

(73) Assignee: NEC Corporation, Minato-ku, Tokyo (JP)

(21) Appl. No.: 18/029,768

(22) PCT Filed: Oct. 2, 2020
(86) PCT No.: PCT/JP2020/037562

§ 371 Date: Mar. 31, 2023

(51) Int. Cl. G06T 7/73

(52) U.S. Cl. CPC G06T 7/74; G06T 2207/30204; G06T 2207/30201

(57) ABSTRACT

A position estimation system includes: an image acquisition unit that obtains an image for estimation including a target that is disposed out of an imaging range of an imaging unit, by imaging a reflecting unit that reflects a light and that is disposed in the imaging range of the imaging unit; a first estimation unit that estimates a first relative position that is a position of the reflecting unit with respect to the imaging unit, on the basis of the image for estimation; and a second estimation unit that estimates a second relative position that is a position of the target with respect to the imaging unit, on the basis of the image for estimation and the first relative position. According to such a position estimation system, it is possible to properly estimate a positional relationship between the imaging unit and the target.

### TECHNICAL FIELD

This disclosure relates to a position estimation system, a position estimation method, and a computer program that estimate a positional relationship with a target.

### BACKGROUND ART

A known system of this type performs alignment (calibration) between an imaging unit and a target that is an imaging target of the imaging unit. For example, Patent Literature 1 discloses a technique/technology of calibrating a head-mounted display on the basis of a captured image of a mirror image of a user who wears the head-mounted display. Patent Literature 2 discloses a technique/technology of calibrating a stereo camera by arranging two mirrors.

As another related technology, for example, Patent Literature 3 discloses a technique/technology of correcting a distortion of a curved mirror image reflected on goggles by using a marker in image data as a clue.

### CITATION LIST

### Patent Literature

Patent Literature 1: JP2016-057634A

Patent Literature 2: JP2018-163111A

Patent Literature 3: JP2020-088591A

### SUMMARY

### Technical Problem

This disclosure aims to improve the related techniques/technologies described above.

### Solution to Problem

A position estimation system according to an example aspect of this disclosure includes: an image acquisition unit that obtains an image for estimation including a target that is disposed out of an imaging range of an imaging unit, by imaging a reflecting unit that reflects a light and that is disposed in the imaging range of the imaging unit; a first estimation unit that estimates a first relative position that is a position of the reflecting unit with respect to the imaging unit, on the basis of the image for estimation; and a second estimation unit that estimates a second relative position that is a position of the target with respect to the imaging unit, on the basis of the image for estimation and the first relative position.

A position estimation method according to an example aspect of this disclosure includes: obtaining an image for estimation including a target that is disposed out of an imaging range of an imaging unit, by imaging a reflecting unit that reflects a light and that is disposed in the imaging range of the imaging unit; estimating a first relative position that is a position of the reflecting unit with respect to the imaging unit, on the basis of the image for estimation; and estimating a second relative position that is a position of the target with respect to the imaging unit, on the basis of the image for estimation and the first relative position.

A computer program according to an example aspect of this disclosure operates a computer: to obtain an image for estimation including a target that is disposed out of an imaging range of an imaging unit, by imaging a reflecting unit that reflects a light and that is disposed in the imaging range of the imaging unit; to estimate a first relative position that is a position of the reflecting unit with respect to the imaging unit, on the basis of the image for estimation; and to estimate a second relative position that is a position of the target with respect to the imaging unit, on the basis of the image for estimation and the first relative position.

### BRIEF DESCRIPTION OF DRAWINGS

FIG. 1 is a block diagram illustrating a hardware configuration of a position estimation system according to a first example embodiment.

FIG. 2 is a block diagram illustrating a functional configuration of the position estimation system according to the first example embodiment.

FIG. 3 is a side view illustrating an arrangement example of an imaging unit, a target, and a reflecting member.

FIG. 4 is a flowchart illustrating a flow of operation of the position estimation system according to the first example embodiment.

FIG. 5 is a schematic configuration diagram illustrating a configuration of a reflecting member and a marker according to a second example embodiment.

FIG. 6A to FIG. 6C are diagrams illustrating examples of a shape of the marker detected in the position estimation system according to the second example embodiment.

FIG. 7A to FIG. 7C are conceptual diagrams illustrating an example of a method of detecting the reflecting member by using the marker.

FIG. 8 is a diagram illustrating an example of a drawing pattern displayed on the target.

FIG. 9 is a diagram illustrating an example of an image obtained by a position estimation system according to a fourth example embodiment.

FIG. 10 is a block diagram illustrating a functional configuration of a position estimation system according to a fifth example embodiment.

FIG. 11 is a flowchart illustrating a flow of operation of the position estimation system according to the fifth example embodiment.

FIG. 12 is a flowchart illustrating a flow of operation of a position estimation system according to a sixth example embodiment.

FIG. 13 is a flowchart illustrating a flow of a process of estimating a position of the reflecting member by a position estimation system according to a ninth example embodiment.

FIG. 14 is a flowchart illustrating a flow of a process of estimating a position of the target by the position estimation system according to the ninth example embodiment.

### DESCRIPTION OF EXAMPLE EMBODIMENTS

Hereinafter, a position estimation system, a position estimation method, and a computer program according to example embodiments will be described with reference to the drawings.

### First Example Embodiment

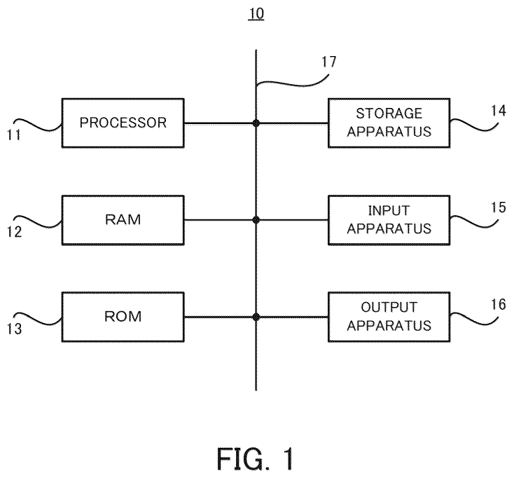

A position estimation system according to a first example embodiment will be described with reference to FIG. 1 to FIG. 4.

### (Hardware Configuration)

First, with reference to FIG. 1, a hardware configuration of the position estimation system according to the first example embodiment will be described. FIG. 1 is a block diagram illustrating the hardware configuration of the position estimation system according to the first example embodiment.

As illustrated in FIG. 1, a position estimation system 10 according to the first example embodiment includes a processor 11, a RAM (Random Access Memory) 12, a ROM (Read Only Memory) 13, and a storage apparatus 14. The position estimation unit 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 is configured to read a computer program. For example, the processor 11 reads a computer program stored by at least one of the RAM 12, the ROM 13 and the storage apparatus 14. Alternatively, the processor 11 may read a computer program stored in a computer-readable recording medium by using a not-illustrating recording medium reading apparatus. The processor 11 may obtain (i.e., may read) a computer program from a not-illustrated apparatus disposed outside the position estimation system 10, through a network interface. The processor 11 controls the RAM 12, the storage apparatus 14, the input apparatus 15, and the output apparatus 16 by executing the read computer program. Especially in the example embodiment, when the processor 11 executes the read computer program, a functional block for estimating a positional relationship (i.e., a relative position) of an imaging unit, a target, and a reflecting member is realized or implemented in the processor 11. As the processor 11, one of a CPU (Central Processing Unit), a GPU (Graphics Processing Unit), a FPGA (field-programmable gate array), a DSP (Demand-Side Platform), and an ASIC (Application Specific Integrated Circuit) may be used, or a plurality of them may be used in parallel.

The RAM 12 temporarily stores the computer programs to be executed by the processor 11. The RAM 12 temporarily stores the data that is temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that is stored for a long term by the position estimation system 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the position estimation system 10. The input apparatus 15 may include, for example, at least one of a keyboard, a mouse, and a touch panel.

The output apparatus 16 is an apparatus that outputs information about the position estimation system-10 to the outside. For example, the output apparatus 16 may be a display apparatus (e.g., a display) that is configured to display the information about the position estimation system 10.

### (Functional Configuration)

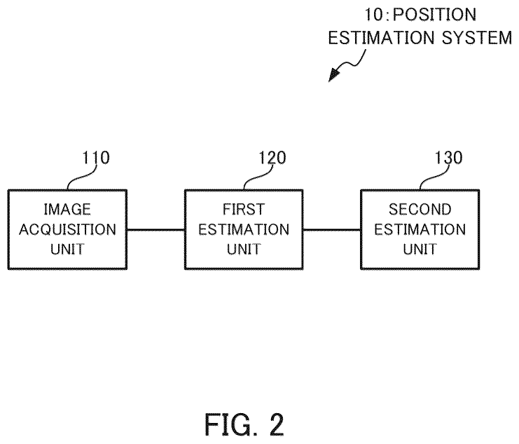

Next, with reference to FIG. 2, a functional configuration of the position estimation system 10 according to the first example embodiment will be described. FIG. 2 is a block diagram illustrating the functional configuration of the position estimation system according to the first example embodiment.

As illustrated in FIG. 2, the position estimation system 10 according to the first example embodiment includes, as processing blocks or physical processing circuits for realizing its functions, an image acquisition unit 110, a first estimation unit 120, and a second estimation unit 130. Each of the image acquisition unit 110, the first estimation unit 120, and the estimation unit 130 may be realized or implemented by the processor 11 (see FIG. 1), for example. The position estimation system 10 according to the first example embodiment is configured to estimate the positional relationship of the imaging unit, the target, and the reflecting member. Each of the imaging unit, the target, and the reflecting member will be described in detail below, together with a configuration of each component of the position estimation system 10.

The image acquisition unit 110 is configured to obtain an image for estimation that is to estimate the positional relationship of the imaging unit, the target, and the reflecting member. The image acquisition unit 110 obtains the image for position estimation from the imaging unit. The imaging unit is configured as a camera, for example, and is disposed at a position at which the target is out of an imaging range. Therefore, the target may not be directly imaged by the imaging unit. The imaging unit, however, may be allowed to indirectly image the target through the reflecting member, by arranging the reflecting member that reflects a light in the imaging range. The image acquisition unit 110 obtains an image in which the target is imaged through the reflecting member in this manner, as the image for estimation. Therefore, the image for estimation is an image including the reflecting member and the target that is imaged through the reflecting member. The image for estimation may entirely include an target, or may only partially include the target. The reflecting member for capturing the image for estimation is configured as a member with a higher light reflectance, such as a mirror. A specific example of the reflecting member will be described in detail in another example embodiment described later. The image for estimation obtained by the image acquisition unit 110 is configured to be outputted to the first estimation unit 120.

The first estimation unit 120 is configured to estimate the position of the reflecting member with respect to the imaging unit (i.e., the positional relationship between the imaging unit and the reflecting member) on the basis of the image for estimation obtained by the image acquisition unit 110. The first estimation unit 120 estimates the positional relationship between the imaging unit and the reflecting member, for example, on the basis of the position of the reflecting member in the image for estimation. More specific processing details of the first estimation unit 120 will be described in another example embodiment described later. Information about the positional relationship between the imaging unit and the reflecting member estimated by the first estimation unit 120 (hereinafter referred to as a “first relative position” as appropriate) is outputted to the second estimation unit 130 together with the image for estimation.

The second estimation unit 130 is configured to estimate the position of the target with respect to the imaging unit (that is, the positional relationship between the imaging unit and the target) on the basis of the image for estimation obtained by the image acquisition unit 110 and the first relative position estimated by the first estimation unit 120. The second estimation unit 130 estimates the positional relationship between the imaging unit and the reflecting member, for example, on the basis of the position of the target reflected to the reflecting member in the image for estimation and the first relative position. More specific processing details of the second estimation unit 130 will be described in another example embodiment described later. The second estimation unit 130 may have a function of outputting information about the estimated positional relationship between the imaging unit and the target (hereinafter referred to as a “second relative position” as appropriate). The second estimation unit 130 may output, for example, information about the second relative position, as information used for calibration of the imaging unit.

### (Arrangement Example of Imaging Unit and the Like)

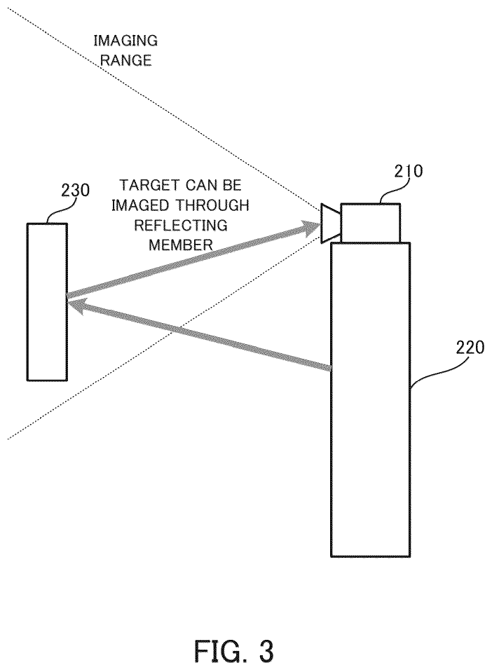

Next, with reference to FIG. 3, the positional relationship of the respective units whose positions are estimated by the position estimation system according to the first example embodiment (specifically, the imaging unit, the target, and the reflecting member) will be specifically described. FIG. 3 is a side view illustrating an arrangement example of the imaging unit, the target, and the reflecting member.

As illustrated in FIG. 3, an imaging unit 210 is disposed to be installed on a target 220, for example. In this case, the imaging unit 210 and the target 220 may be integrally configured. An example of such an arrangement is digital signage with a camera. Since the digital signage and the camera are installed to face in the same direction (e.g., the camera is disposed to image a user who browses the digital signage), the digital signage cannot be directly imaged by the camera. The position estimation system 10 according to the first example embodiment estimates the positional relationship between the imaging unit 210 and the target 220 when the target is disposed not to be included in an imaging range of the imaging unit 210, as in the above example.

A reflecting member 230 is disposed in the imaging range of the imaging unit 210 so as to image the target 220 by using the imaging unit 210. In this way, a light from the target 220 is reflected by the reflecting member 230 and reaches the imaging unit 210, and it is thus possible to image the target 220 by suing the imaging unit 210. The reflecting member 230 may be in a fixed position. Alternatively, the reflecting member 230 may be configured to be movable (e.g., a person may hold it in the hand to adjust its position).

The above arrangement example is an example, and even in an arrangement that is different from the above arrangement example, it is possible to estimate the positional relationship in the position estimation system 10 according to the first example embodiment. Specifically, in a situation in which the target 220 is not included in the imaging range of the imaging unit 210, in which the reflecting member 230 is included in the imaging range of the imaging unit, and in which the target 220 can be imaged through the reflecting member 230 from the imaging unit 210, it is possible to estimate the positional relationship in the position estimation system 10 according to the first example embodiment.

### (Flow of Operation)

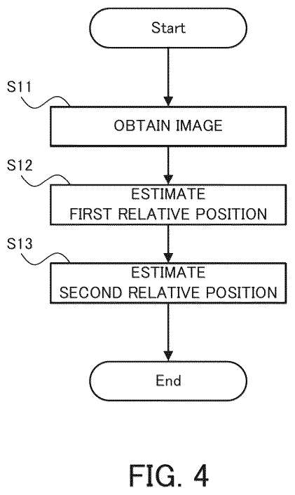

Next, a flow of operation of the position estimation system 10 according to the first example embodiment will be described with reference to FIG. 4. FIG. 4 is a flowchart illustrating the flow of the operation of the position estimation system according to the first example embodiment.

As illustrated in FIG. 4, when the operation of the position estimation system 10 according to the first example embodiment is started, first, the image acquisition unit 110 obtains the image for estimation (step S11). At least one image for estimation may be obtained, but a plurality of images for estimation may be also obtained. A configuration for obtaining a plurality of images for estimation will be described in detail in another example embodiments described later.

When the image for estimation is obtained, the first estimation unit 120 estimates the first relative position (i.e., the positional relationship between the imaging unit 210 and the reflecting member 230) on the basis of the obtained image for estimation (step S12). The first relative position may be estimated, for example, as three-dimensional coordinates of the reflecting member 230 in a coordinate system based on the imaging unit 210. Alternatively, the first relative position may be estimated as an angle of the reflecting member 230 viewed from the imaging unit 210.

When the first relative position is estimated, the second estimation unit 130 estimates the second relative position (i.e., the positional relationship between the imaging unit 210 and the target 220) on the basis of the obtained image for estimation and the estimated first relative position (step S13). The second relative position may be estimated, for example, as three-dimensional coordinates of the target 220 in the coordinate system based on the imaging unit 210. Alternatively, the second relative position may be estimated as an angle of the target 220 viewed

### (Technical Effect)]

Next, a technical effect obtained by the position estimation system 10 according to the first example embodiment will be described.

As described in FIG. 1 to FIG. 4, in the position estimation system 10 according to the first example embodiment, the position of the target 220 with respect to the imaging unit 210 is estimated on the basis of the image for estimation. Here, in particular, since the target 220 is installed out of the imaging range of the imaging unit 210, it is hardly possible to directly image the target 220 by using the imaging unit 210 (e.g., see FIG. 3). Therefore, even if an image captured by the imaging unit 210 is used as it is, it is hardly possible to estimate the positional relationship between the imaging unit 210 and the target 220. In this example embodiment, however, the target is indirectly imaged by the imaging unit 210, by using the reflecting member 230. By using the image for estimation imaged in this way, it is possible to estimate the positional relationship between the imaging unit 210 and the target 220. Therefore, according to the position estimation system 10 in the first example embodiment, it is possible to properly estimate the positional relationship between the imaging unit 210 and the target 220 that is not included in the imaging range of the imaging unit 210.

### Second Example Embodiment

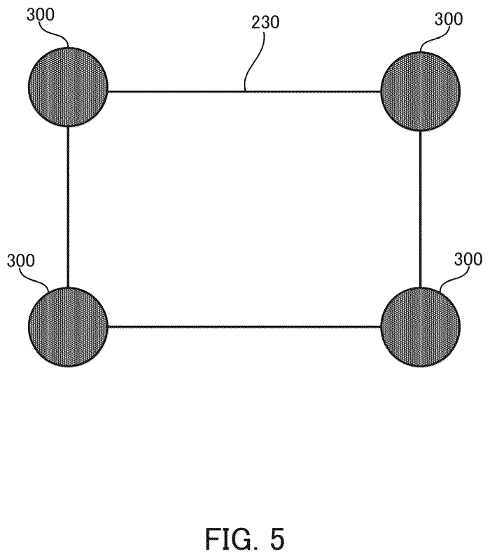

The position estimation system 10 according to a second example embodiment will be described with reference to FIG. 5. The second example embodiment describes an example of the reflecting member 230, and may be the same as the first example embodiment in the system configuration and operation, or the like. For this reason, the parts that differ from the first example embodiment will be described in detail below, and a description of the other overlapping parts will be omitted as appropriate.

### (Configuration of Reflecting Member)

First, with reference to FIG. 5, a configuration of the reflecting member 230 used in the position estimation system 10 according to the second example embodiment will be described. FIG. 5 is a schematic configuration diagram illustrating the configuration of the reflecting member and a marker according to the second example embodiment.

As illustrated in FIG. 5, the reflecting member 230 according to the second example embodiment is configured as a rectangular planar member, and have markers 300 attached at its four corners. The markers 300 are attached to detect the position of the reflecting member 230 in the image for estimation. Therefore, the marker 300 is preferably configured to be easily recognized in the image for estimation. More specifically, the marker 300 is preferably configured such that the position thereof can be easily detected by performing predetermined image processing on the image for estimation, for example.

When the target 220 is a digital signage, the reflecting member 230 may be configured as a movable mirror (e.g., a planar mirror mounted on a stand with rollers). In this case, in a condition in which the target 220 displays a predetermined calibration pattern (e.g., a grid pattern), the movable reflecting member 230 with the markers 300 attached may be moved to a position at which the pattern displayed in the target 220 is included in a field of view of the camera.

Attached positions of the markers 300 are not limited to the four corners of the reflecting member 230. The attached positions of the markers 300 are preferably set to suitable positions depending on a shape of the reflecting member 230. For example, the markers 300 are preferably arranged so as to detect the shape of the reflecting member 230 (in other words, an area occupied by the reflecting member 230 on the image for estimation) by detecting each of the markers 300. The number of the markers 300 is also not limited to four. As for the number of the markers 300, 15 a suitable number of markers are preferably arranged at appropriate positions depending on the shape of the reflecting member 230. For example, more markers 300 may be attached when the reflecting member 230 is configured as a member of a more complex shape. Alternatively, when the shape of the reflecting member 230 can be recognized by fewer markers, the number of markers 300 attached may be less than or equal to three.

There is no particular limitation on the color and shape of the marker 300. When a plurality of markers 300 are attached, each marker 300 may be in a different color and shape. If the color and shape of the marker 300 are set to be easily recognized on the image for estimation, it is possible to more properly detect the reflecting member 230. A specific example of such a color and shape of the marker 300 will be described in detail in another example embodiments described later.

### (Technical Effect)

Next, a technical effect obtained by the position estimation system 10 according to the second example embodiment will be described.

As described in FIG. 5, in the position estimation system 10 according to the second example embodiment, the markers 300 are attached to the reflecting member 230. In this way, it is possible to easily detect the position of the reflecting member 230 on the basis of the positions of the markers. As a result, it is possible to properly estimate the positional relationship between the imaging unit 210 and the reflecting member 230 (i.e., the first relative position). For example, when the markers 300 are not attached, it is hard to estimate the positional relationship with the reflecting member 230 if the position and direction of the reflecting member 230 are not determined in advance (i.e., are not known). Even in such a case, it is possible to easily detect the position and direction of the reflecting member 230 from the image for estimation by attaching the markers 300 to the reflecting member 230.

### Third Example Embodiment

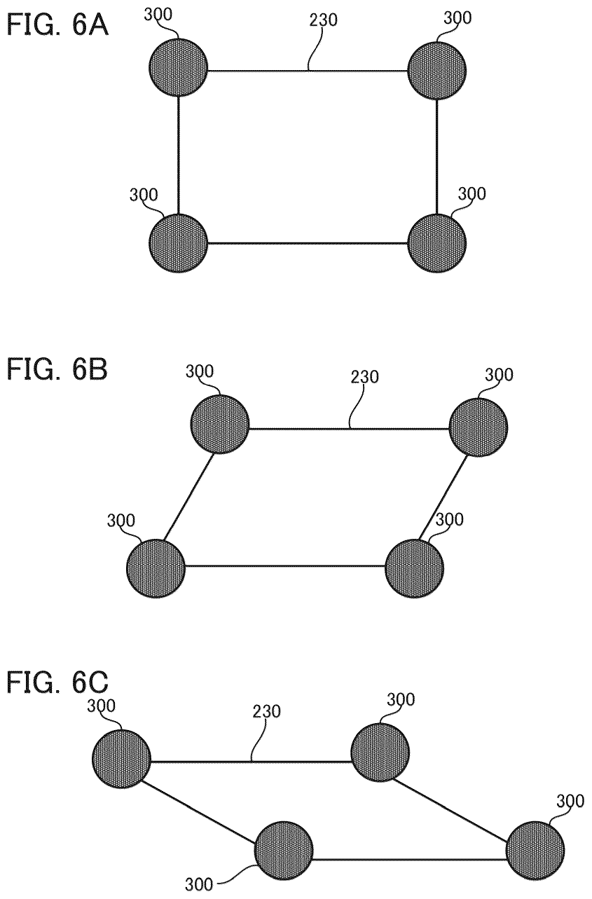

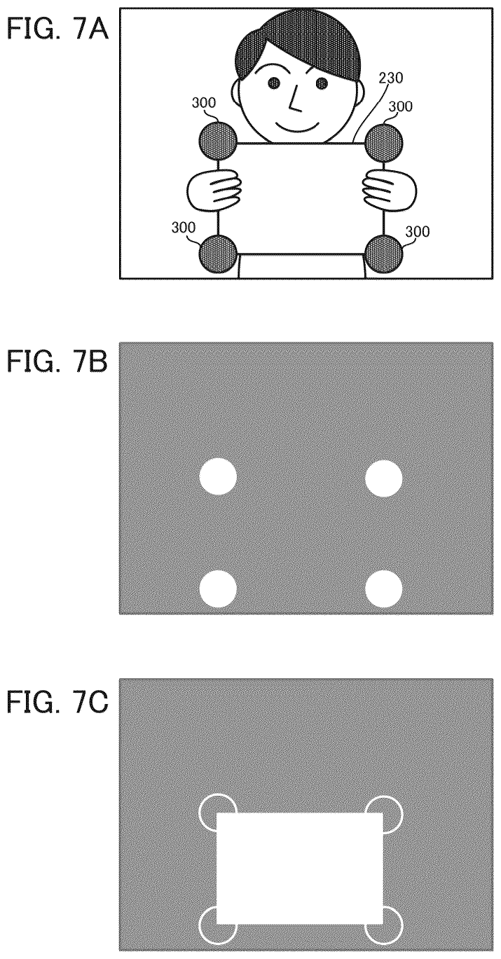

The position estimation system 10 according to a third example embodiment will be described with reference to FIG. 6A to FIG. 7C. The third example embodiment describes a more specific configuration example of the reflecting member 230 described in the second example embodiment, and may be the same as the first and second example embodiments in the system configuration and operation, or the like. For this reason, the parts that differ from the first and second example embodiments will be described in detail below, and a description of the other overlapping parts will be omitted as appropriate.

### (Shape of Marker)

First, the shape of the marker used in the position estimation system 10 according to the third example embodiment will be described with reference to FIG. 6A to FIG. 6C. FIG. 6A to FIG. 6C are diagrams illustrating examples of the shape of the marker detected in the position estimation system according to the second example embodiment. In FIG. 6, the same components as those illustrated in FIG. 5 carry the same reference numerals.

As illustrated in FIG. 6A, FIG. 6B and FIG. 6C, the markers 300 attached to the reflecting member 230 according to the third example embodiment are spherical. The marker 300 may be configured, for example, as a resin or metal ball.

FIG. 6A, FIG. 6B and FIG. 6C illustrate the reflecting member 230 viewed from different angles. As can be seen by comparing these figures, when the marker 300 is set to be spherical, even if the reflecting member 230 is imaged from any angle, the marker 300 is reflected in a circle on the image. Therefore, even if an imaging angle of the reflecting member 230 varies, it is possible to easily detect the marker 300 by recognizing a circular object in the image for estimation.

Even if the marker 300 is spherical, due to lens distortion, the marker 300 on the image for estimation may not be circular (i.e., a perfect circle). For example, if the marker 300 is located close to an end of the image for estimation, the marker 300 may be a distorted circular. In such a case, for example, a distortion correcting process corresponding to the lens distortion may be performed. In this way, it is possible to detect the marker 300 while reducing an influence of the distortion. A specific description of the distortion correction will be omitted here because the existing techniques/technologies can be properly adopted.

The above example describes that the marker 300 is spherical, but any shape, other than spherical, that is not significantly changed by an angle of view may obtain the same effect.

### (Color of Marker)

Next, the color of the marker used in the position estimation system 10 according to the third example embodiment will be described with reference to FIG. 7A to FIG. 7C. FIG. 7A to FIG. 7C are conceptual diagrams illustrating an example of a method of detecting the reflecting member by using the marker. In FIG. 6, the same components as those illustrated in FIG. 5 to FIG. 6C carry the same reference numerals.

The color of the markers 300 attached to the reflecting member 230 according to the third example embodiment is a color that does not exist in nature or in an imaging scene of the image for estimation, or is a color that hardly overlaps with another object (hereinafter referred to as a “specific color” as appropriate). An example of the specific color is, for example, purple, but which color is actually used for the marker 300 may be properly set depending on the imaging scene or the like. For example, when imaging is performed in nature with a lot of green, the marker 300 is preferably set in a color other than green. Alternatively, when the imaging is performed in an inorganic room based on a gray color, the marker 300 is preferably set in a color other than gray. Furthermore, the color of the marker 300 may be set to be a complementary color of the color of an object that is desirably distinguished reliably from the marker 300 (i.e., a color that is diametrically opposite on a color wheel).

When the marker 300 is in the specific color as described above, the marker 300 and another object can be easily distinguished from each other in the image for estimation. Hereinafter, a detection method when the color of the marker 300 is the specific color will be specifically described.

As illustrated in FIG. 7A, it is assumed that an image of a person holding the reflecting member 230 in the hand is obtained as the image for estimation. When the marker 300 is in the specific color, it is possible to properly detect an area in which the marker 300 exists, as illustrated in FIG. 7B, by performing image processing for extracting an area in the specific color, on the image for estimation. As preprocessing of the processing for extracting the specific color, a process of transforming the image for estimation to an HSV color image may be performed. If the positions of the markers 300 can be detected, as illustrated in FIG. 7C, it is possible to properly estimate the position of the reflecting member 230.

### (Technical Effect)

Next, a technical effect obtained by the position estimation system 10 according to the third example embodiment will be described.

As described in FIG. 6A to FIG. 7C, in the position estimation system 10 according to the third example embodiment, the markers 300 attached to the reflecting member 230 are configured to be spherical or in the specific color. In this way, it is possible to easily detect the markers 300 by using the shape and color characteristics. Therefore, it is possible to more properly estimate the position of the reflecting member 230.

### Fourth Example Embodiment

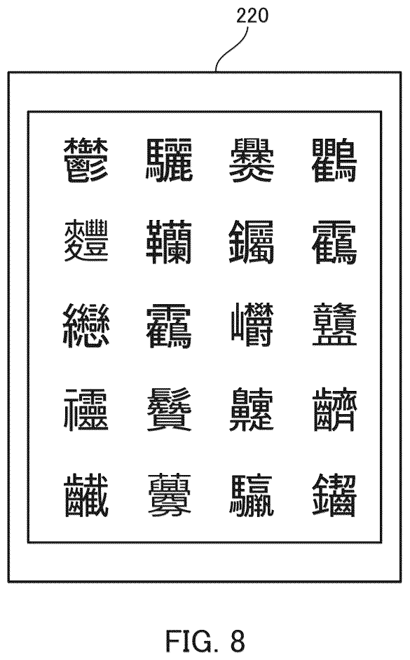

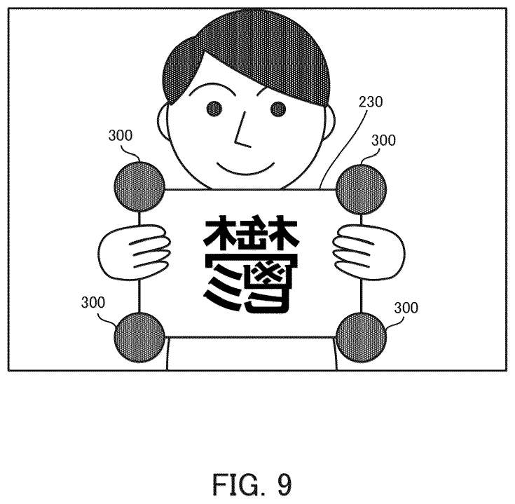

The position estimation system 10 according to a fourth example embodiment will be described with reference to FIG. 8 and FIG. 9. The fourth example embodiment describes the target 220 in detail, and may be the same as the first to third example embodiments in the system configuration and operation, or the like. For this reason, the parts that differ from the first to third example embodiments will be described in detail below, and a description of the other overlapping parts will be omitted as appropriate.

### (Display of Drawing Pattern)

First, with reference to FIG. 8, a description will be given to a display operation of displaying a drawing pattern by the target 220 that is a position estimation target of the position estimation system 10 according to the fourth example embodiment. FIG. 8 is a diagram illustrating an example of a drawing pattern displayed on the target.

As illustrated in FIG. 8, the target 220 according to the fourth example embodiment is configured as a display apparatus with a display that is configured to display an image or a video. The target 220 may be a digital signage, for example.

The target 220 according to the fourth example embodiment displays a drawing pattern that varies depending on its display position when the image for estimation is captured. An example of such a drawing pattern is, for example, a drawing pattern in which a plurality of different characters are arranged, as illustrated in FIG. 8. In this case, Kanji or Chinese characters with a relatively large number of strokes as illustrated in FIG. 8, or a plurality of characters that do not have any common part (e.g., Kanji that does not have a common radical) are preferably displayed to have a reliably different pattern depending on the display position. Furthermore, it is preferable to reduce a blank where there are no characters. The drawing pattern may be not a character, but a design pattern, an illustration, a photograph or the like.

### (Estimation of Position of Target)

Next, a method of estimating the second relative position by the position estimation system 10 according to the fourth example embodiment will be described with reference to FIG. 9. FIG. 9 is a diagram illustrating an example of an image obtained by the position estimation system according to the fourth example embodiment.

When the target 220 is entirely reflected in the image, it is relatively easy to estimate the position of the target 220 from the image for estimation. When the target 220 is only partially included in the image for estimation, however, it is hard to estimate the position of the target 220 from the image for estimation if it is not known which part of the target 220 is included.

In contrast, as illustrated in FIG. 9, when a drawing pattern is displayed on the target 220, the drawing pattern is also reflected in the image for estimation. Since this drawing pattern is a drawing pattern that varies depending on the display position, as described above, even if the drawing pattern is only partially reflected, it is possible to recognize which part of the target 220. For example, in the example illustrated in FIG. 9, a Kanji of “depression” is reflected (the Kanji of “depression” is horizontally inverted because it is a mirror image). This shows that the image for estimation is an upper left part of the target (see FIG. 8). It is possible to estimate which part of the target 220 is reflected with higher accuracy by matching corresponding points between the drawing pattern displayed on the target 220 and the drawing pattern included in the image for estimation.

### (Technical Effect)

Next, a technical effect obtained by the position estimation system 10 according to the fourth example embodiment will be described.

As described in FIG. 8 and FIG. 9, in the position estimation system 10 according to the fourth example embodiment, the image for estimation is captured in a condition in which the drawing pattern that varies depending on the display position is displayed on the target 220. Therefore, even if the target 220 is only partially reflected in the image for estimation, it is possible to recognize which part of the target 220 is reflected. Consequently, it is possible to properly estimate the position of the target 220 from the image for estimation.

When the target 220 is not the display apparatus, a drawing pattern is physically superimposed on the target 220 (e.g., a cover with a printed drawing pattern is put), by which it is possible to obtain the same benefits as those when the drawing pattern is displayed.

In the calibration, for example, a technique or method of imaging a drawing pattern such as a chessboard (a white and black grate-like drawing pattern) is sometimes used. In the drawing pattern of a uniform pattern such as the chessboard, however, as described above, when the target 220 is only partially reflected in the image for estimation, it is hard to estimate which part of the target 220 is reflected. In this example embodiment, however, since the drawing pattern that varies depending on the display position is displayed on the target 220 as described above, it is possible to properly estimate the position of the target 220.

### Fifth Example Embodiment

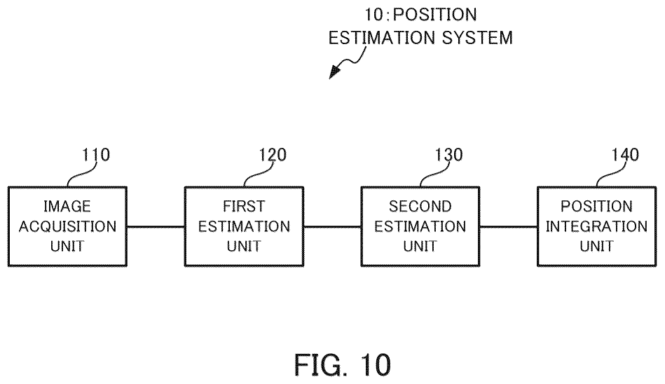

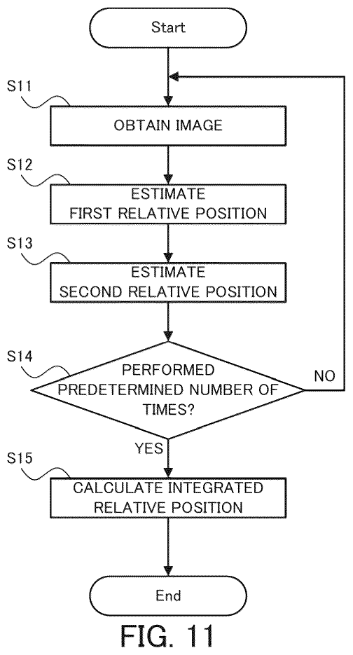

The position estimation system 10 according to a fifth example embodiment will be described with reference to FIG. 10 and FIG. 11. The fifth example embodiment is partially different from the first to fourth example embodiments only in the configuration and operation, and may be the same as the first to fourth example embodiments in other parts. For this reason, the parts that differ from the first to fourth example embodiments will be described in detail below, and a description of the other overlapping parts will be omitted as appropriate.

### (Functional Configuration)

First, with reference to FIG. 10, a functional configuration of the position estimation system 10 according to the fifth example embodiment will be described. FIG. 10 is a block diagram illustrating the functional configuration of the position estimation system according to the fifth example embodiment. In FIG. 10, the same components as those illustrated in FIG. 2 carry the same reference numerals.

As illustrated in FIG. 10, the position estimation system 10 according to the fifth example embodiment includes, as processing blocks or physical processing circuits for realizing its functions, the image acquisition unit 110, the first estimation unit 120, the second estimation unit 130, and a position integration unit 140. That is, the position estimation system 10 according to the fifth example embodiment further includes a position integration unit 140 in addition to the configuration in the first example embodiment (see FIG. 2). The position integration unit 140 may be realized or implemented by the processor 11 (see FIG. 1), for example.

The position integration unit 140 is configured to calculate an integrated relative position by integrating a plurality of second relative positions. That is, the position integration unit 140 is configured to calculate one integrated second relative position that takes into account each of the plurality of second relative positions. The plurality of second relative positions may be estimated by using a plurality of images for estimation. Existing techniques/technologies can be applied to an integration process performed by the position integration unit 140 as appropriate, and an example is a process of calculating a mean value or a median value of the plurality of second relative positions. The position integration unit 140 outputs the calculated integrated relative position, as a final second relative position (i.e., the positional relationship between the imaging unit 210 and the target 220).

### (Flow of Operation)

Next, a flow of operation of the position estimation system 10 according to the fifth example embodiment will be described with reference to FIG. 11. FIG. 11 is a flowchart illustrating the flow of the operation of the position estimation system according to the fifth example embodiment. In FIG. 11, the same steps as those illustrated in FIG. 4 carry the same reference numerals.

As illustrated in FIG. 11, when the operation of the position estimation system 10 according to the fifth example embodiment is started, first, the image acquisition unit 110 obtains the image for estimation (the step S11). When the image for estimation is obtained, the first estimation unit 120 estimates the first relative position (i.e., the positional relationship between the imaging unit 210 and the reflecting member 230) on the basis of the obtained image for estimation (the step S12). When the first relative position is estimated, the second estimation unit 130 estimates the second relative position (i.e., the positional relationship between the imaging unit 210 and the target 220) on the basis of the obtained image for estimation and the estimated first relative position (the step S13). Up to this point, the same steps as those in the first example embodiment are performed.

Subsequently, especially in the position estimation system 10 according to the fifth example embodiment, the position integration unit 140 determines whether or not a process of the step S11 to the step S13 is performed a predetermined number of times (step S14). The “predetermined number of times” here is a threshold for determining whether or not a sufficient number of second relative positions for the integration are estimated, and is set in advance by a system administrator or the like.

When it is determined that the process of the step S11 to the step S13 is not performed the predetermined number of times (the step S14: NO), the process is repeated from the step S11 again. Therefore, until a sufficient number of second relative positions for the integration are accumulated, a plurality of images for estimation are obtained, a plurality of first relative positions are estimated, and a plurality of second relative positions are estimated. The position integration unit 140 may include a storage unit that stores a plurality of second relative positions estimated by the repetition process described above. The storage unit in this case may be realized or implemented by the storage apparatus 14 (see FIG. 1), for example.

When it is determined that the process of the step S11 to the step S13 is performed the predetermined number of times (the step S14: YES), the position integration unit 140 calculates the integrated relative position by integrating the plurality of second relative positions estimated so far (step S15).

The above example exemplifies an operation of estimating a sufficient number of second relative positions and finally calculating the integrated relative position, but an operation of calculating the integrated relative position at each time that a new second relative position is estimated (in other words, an operation of updating the integrated relative position at any time) may be performed. In this case, when the second relative position to be secondly estimated is calculated, the position integration unit 140 integrates the firstly estimated second relative position and the secondly estimated second relative position, and calculates an integrated relative position. Then, when the second relative position to be thirdly estimated is calculated, the position integration unit 140 integrates the already calculated integrated relative position (i.e., obtained by integrating the firstly estimated second relative position and the secondly estimated second relative position) and the newly estimated second relative position that is thirdly estimated, and calculates a new integrated relative position. In this way, the position integration unit 140 calculates the integrated relative position at each time that the new second relative position is estimated. To achieve such an operation, the position integrator 140 may include a storage unit that stores past integrated relative positions. The storage unit in this case may be realized or implemented by the storage apparatus 14 (see FIG. 1), for example. A series of processing steps described above may be ended when the number of calculations of the integrated relative position (in other words, the number of updates) reaches a predetermined number of times.

### (Technical Effect)

Next, a technical effect obtained by the position estimation system 10 according to the fifth example embodiment will be described.

As described in FIG. 10 and FIG. 11, in the position estimation system 10 according to the fifth example embodiment, the integrated relative position is calculated from the plurality of second relative positions. Since the second relative positions to be integrated are relatively estimated from different images for estimation, the integrated relative position is a value that takes into account a plurality of images. Therefore, if the integrated relative position is calculated, it is possible to estimate the positional relationship between the imaging unit 210 and the target 220 more properly than when one second relative position is estimated from one image for estimation.

### Sixth Example Embodiment

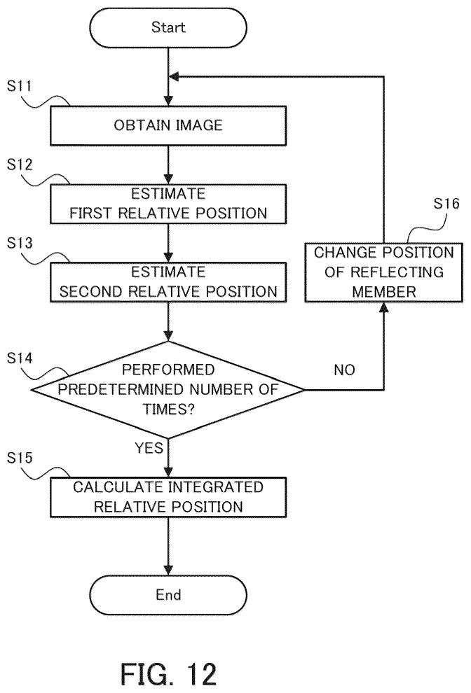

The position estimation system 10 according to a sixth example embodiment will be described with reference to FIG. 12. The sixth example embodiment is partially different from the fifth example embodiment only in the operation, and may be the same as the fifth example embodiment in other parts. For this reason, the parts that differ from the fifth example embodiment will be described in detail below, and a description of the other overlapping parts will be omitted as appropriate.

### (Flow of Operation)

First, a flow of operation of the position estimation system 10 according to the sixth example embodiment will be described with reference to FIG. 12. FIG. 12 is a flowchart illustrating the flow of the operation of the position estimation system according to the sixth example embodiment. In FIG. 12, the same steps as those illustrated in FIG. 4 and FIG. 11 carry the same reference numerals.

As illustrated in FIG. 12, when the operation of the position estimation system 10 according to the sixth example embodiment is started, first, the image acquisition unit 110 obtains the image for estimation (the step S11). When the image for estimation is obtained, the first estimation unit 120 estimates the first relative position (i.e., the positional relationship between the imaging unit 210 and the reflecting member 230) on the basis of the obtained image for estimation (the step S12). When the first relative position is estimated, the second estimation unit 130 estimates the second relative position (i.e., the positional relationship between the imaging unit 210 and the target 220) on the basis of the obtained image for estimation and the estimated first relative position (the step S13). Subsequently, the position integration unit 140 determines whether or not the process of the step S11 to the step S13 is performed a predetermined number of times (the step S14).

When it is determined that the process of the step S11 to the step S13 is not performed the predetermined number of times (the step S14: NO), especially in the position estimation system according to the sixth example embodiment, the position (or angle) of the reflecting member 230 is changed (step S16). Specifically, the position of the reflecting member 230 is changed such that the positional relationship between the imaging unit 210 and the reflecting member 230 (i.e., the first relative position) is changed. The position of the reflecting member 230 may be changed by a human hand, or by using a machine or the like.

After the position of the reflecting member 230 is changed, the process of the step S11 to the step S13 is repeated. Therefore, as in the fifth example embodiment already described, until a sufficient number of second relative positions for the integration are accumulated, a plurality of images for estimation are obtained, a plurality of first relative positions are estimated, and a plurality of second relative positions are estimated. In the sixth example embodiment, however, since the position of the reflecting member 230 is changed at each time, the image for estimation obtained in the image acquisition unit 110 in the step S11 is captured in a manner that is different from a previous manner. Consequently, the plurality of second relative positions accumulated by repeating the step S11 to the step S13 are the second relative positions that are estimated from the images for estimation captured under different conditions.

When it is determined that the process of the step S11 to the step S13 is performed the predetermined number of times (the step S14: YES), the position integration unit 140 calculates the integrated relative position by integrating the plurality of second relative positions estimated so far (the step S15).

### (Technical Effect)

Next, a technical effect obtained by the position estimation system 10 according to the sixth example embodiment will be described.

As described in FIG. 12, in the position estimation system 10 according to the sixth example embodiment, the plurality of images for estimation are captured in a condition in which the position of the reflecting member 230 is changed. In this case, each image for estimation has a different influence of the lens distortion or has a different reflection of the marker 300. Such a difference may cause not a few errors in estimation results of the first relative position and the second relative position; however, if the position of the reflecting member 230 is changed and if a plurality of second relative positions are estimated from the images for estimation captured under different imaging conditions, then, by integrating them to calculate the integrated relative position, it is possible to estimate an appropriate second relative position (i.e., the positional relationship between the imaging unit 210 and the target 220) that has a less influence of the error.

### Seventh Example Embodiment

The position estimation system 10 according to a seventh example embodiment will be described. The seventh example embodiment describes a specific example of the reflecting member 230, and may be the same as the first to sixth example embodiments in the system configuration and operation, or the like. For this reason, the parts that differ from the first to sixth example embodiments will be described in detail below, and a description of the other overlapping parts will be omitted as appropriate.

The reflecting member 230 used in the position estimation system 10 according to the seventh example embodiment includes glass, metal, acrylic, and polycarbonate. Since these members have a relatively high light reflectance, it is possible to properly capture the image for estimation in which the target 220 is reflected, through the reflecting member 230.

The reflecting member 230 may be prepared on the assumption of being used for the position estimation system 10, but a member that is originally in the imaging range of the imaging unit 210 may be also diverted as the reflecting member 230. For example, when the target 220 is a digital signage installed in a store, many articles displayed in the store may be included in the imaging range of the imaging unit 210. In such a case, out of those articles, a product including glass, metal, acrylic, or polycarbonate described above may be used as the reflecting member 230.

Specifically, various articles such as furniture, tableware, and electric appliances, may be used as the reflecting member 230. Furthermore, even when the target 220 is installed outside, various objects included in the imaging range of the imaging unit 210 may be diverted as the reflecting member 230. For example, it is possible to use a window glass of a building or a house or the like, as the reflecting member 230.

The reflecting member 230 may also be made of a material with a reflectance that is similar to or higher than those of glass, metal, acrylic, or polycarbonate described above.

### Eighth Example Embodiment

The position estimation system according to an eighth example embodiment will be described. The eighth example embodiment describes a specific example of the reflecting member 230 as in the seventh example embodiment described above, and may be the same as the first to seventh example embodiments in the system configuration and operation, or the like. For this reason, the parts that differ from the first to seventh example embodiments will be described in detail below, and a description of the other overlapping parts will be omitted as appropriate.

The reflecting member 230 used in the position estimation system 10 according to the eighth example embodiment may be an eyeball of a living body. The following description will be made with reference to a human eyeball, but it is possible to use an eyeball of a dog and a cat in the same manner, for example.

It is known that the human eyeball (especially, iris) reflects what the person looks at. Therefore, when a person looks at the target 220, the target 220 may be reflected in the eyeball of the person. Therefore, if the eyeball of the person who looks at the target 220 is imaged by the imaging unit 210, a captured image includes the target 220 that cannot be directly imaged by the imaging unit 210. Therefore, the image captured in this way may be used as the image for estimation. In this case, since it is not necessary to prepare an exclusive member as the reflecting member 230, it is possible to reduce labor and cost. When the target 220 is a digital signage, there is certainly a situation where a person stands still in front of it and looks at the target 220. Therefore, it is possible to capture the image for estimation relatively easily through the eyeball.

The imaging unit 210 is required to be relatively high-definition in order to image an object that is reflected on the human eyeball. However, many cameras installed in the digital signage or the like are installed for the purpose of estimating the line of sight of a person, for example. Specifically, some cameras have a function of estimating which part of the digital signage is seen by a person who looks at the digital signage. In order to realize such a function, the imaging unit 210 is required to be inevitably high-definition. Furthermore, the imaging unit 210 is installed at a position at which the human eyeball is easily imaged. Therefore, this example embodiment that uses the human eyeball has a high affinity with an actual operation example.

### Ninth Example Embodiment

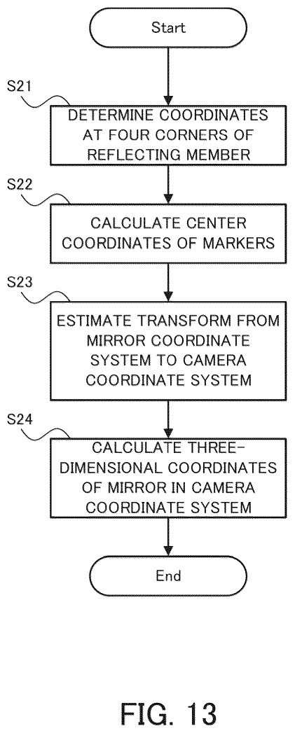

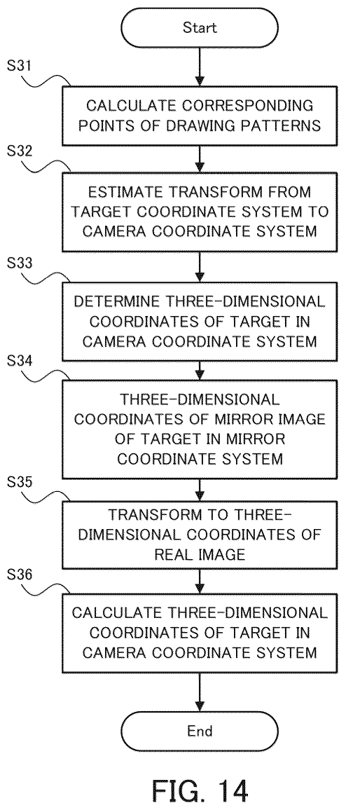

The position estimation system 10 according to a ninth example embodiment will be described with reference to FIG. 13 and FIG. 14. The ninth example embodiment specifically describes the process of estimating the position performed in the first to eighth example embodiments, and may be the same as the first to eighth example embodiments in the system configuration and flow of overall operation, or the like. For this reason, the parts that differ from the first to eighth example embodiments will be described in detail below, and a description of the other overlapping parts will be omitted as appropriate.

### (Process of Estimating Position of Reflecting Member)

First, a flow of a process of estimating the positional relationship between the imaging unit 210 and the reflecting member 230 (i.e., the first relative position) by the position estimation system 10 according to the ninth example embodiment will be described with reference to FIG. 13. FIG. 13 is a flowchart illustrating the flow of the process of estimating the position of the reflecting member by the position estimation system according to the ninth example embodiment. In the following example, as described in the third example embodiment, it is assumed that the markers 300 that are spherical and in the specific color are attached to the reflecting member 230 (see FIG. 6 and FIG. 7, etc.).

As illustrated in FIG. 13, in the process of estimating the first relative position by the position estimation system 10 according to the sixth example embodiment (i.e., the step S12 in FIG. 4), first, a physical size (wₘ, hₘ[mm]) of the reflecting member 230 is measured, and three-dimensional coordinates X^{M}ₘ at the four corners of the reflecting member 230 are determined in a coordinate system based on the reflecting member 230 (hereinafter referred to as a “mirror coordinate system M” as appropriate) (step S21). The three-dimensional coordinates X^{M}ₙ (the unit of [mm]) at the four corners of the reflecting member 230 can be expressed, for example, by the following Equation (1).

$$\begin{matrix}[ Equation 1 ] & \\ {X}_{m}^{M} = [ \begin{matrix}0 & {w}_{m} & {w}_{m} & 0 \\ 0 & 0 & {h}_{m} & {h}_{m} \\ 0 & 0 & 0 & 0\end{matrix} ] & ( 1 )\end{matrix}$$

Subsequently, as described in the third example embodiment (see FIG. 7), the specific color is extracted from the image for estimation and a generalized Hough transform is performed, and center coordinates of the markers 300 attached to the reflecting member 230 are calculated (step S22). The center coordinates of the markers 300 are two-dimensional coordinates X^{I}ₙ (the unit of [pixel]) at the four corners of the reflecting member 230 in an image coordinate system I based on the image for estimation.

Subsequently, a transform from the mirror coordinate system M to a camera coordinate system C based on the imaging unit 21 is estimated by using a method of solving a PnP problem (a problem of estimating the position and posture of a camera from three-dimensional coordinates of n points and two-dimensional coordinates thereof on a captured image) from the three-dimensional coordinates X^{M}ₘ of the reflecting member 230 in the mirror coordinate system M and the two-dimensional coordinates X^{I}ₘ of the reflecting member 230 in the image coordinate system I (step S23). When the PnP problem is solved, existing techniques/methods may be used as appropriate. Specifically, a rotation matrix R_{M→C} and a translation vector t_{M→C} may be estimated in the following Equation (2).

$$\begin{matrix}[ Equation 2 ] & \\ [ \begin{matrix}{X}_{m}^{I} \\ 1\end{matrix} ] = A [ {R}_{M \to C} \vert {t}_{M \to C} ] {X}_{m}^{M} & ( 2 )\end{matrix}$$

The lens distortion is omitted in the above Equation (2), but it is preferable to solve the PnP problem including the lens distortion and to estimate the rotation matrix and the like. Furthermore, A in the Equation (2) is an internal parameter of the imaging unit 210, and may be expressed, for example, as in the following Equation (3).

$$\begin{matrix}[ Equation 3 ] & \\ - A = [ \begin{matrix}{f}_{x} & 0 & {c}_{x} \\ 0 & {f}_{y} & {c}_{y} \\ 0 & 0 & 1\end{matrix} ] & ( 3 )\end{matrix}$$

The internal parameter A of the imaging unit 210 is assumed to be known, but if it is unknown, it may be obtained by an existing calibration technique/technology (e.g., calibration using a chessboard or the like).

Finally, two-dimensional coordinates X^{C}_{M} of the reflecting member 230 in the camera coordinate system C are calculated. The two-dimensional coordinates X^{C}_{M} are the position of the reflecting member 230 with respect to the imaging unit 210 (i.e., the first relative position). The two-dimensional coordinates X^{C}_{M} of the reflecting member 230 in the camera coordinate system

C can be calculated by the following Equation (4).

[Equation 4]

Xₘ^{C}=R_{M→C}Xₘ^{M}+t_{M→C} (4)

As described later, in the process of estimating the position of the target, the rotation matrix and the translation vector obtained in the step S23 can be used as information indicating the position of the reflecting member 230. In such a case, there is no need to calculate the two-dimensional coordinates X^{C}_{M} of the reflecting member 230 in the camera coordinate system C by using the Equation (4).

### (Process of Estimating Position of Target)

Next, a flow of a process of estimating the positional relationship between the imaging unit 210 and the target 220 (i.e., the second relative position) by the position estimation system 10 according to the ninth example embodiment will be described with reference to FIG. 14. FIG. 14 is a flowchart illustrating the flow of the process of estimating he position of the target by the position estimation system according to the ninth example embodiment. In the following example, as described in the fourth example embodiment, it is assumed that the drawing pattern that varies depending on the display position is displayed on the target 220 (see FIG. 8 and FIG. 9, etc.).

As illustrated in FIG. 14, when the process of estimating the second relative position by the position estimation system 10 according to the sixth example embodiment (i.e., the step S13 in FIG. 4) is started, first, the corresponding points are calculated between the drawing pattern displayed on the target 220 and the drawing pattern in the image for estimation by a corresponding point matching of local feature quantities (step S31). The local feature quantities may use, for example, a SIFT (Scaled Invariance Feature Transform) or the like. In the corresponding point matching, a left-right determination may be made on the drawing pattern displayed on the target 220, and the corresponding point with the image for estimation that is captured in a horizontally inverted condition (i.e., the mirror image) may be searched for. In this case, the corresponding point of the drawing pattern displayed on the target 220=three-dimensional coordinates X^{D}ₜ₋ₘᵢᵣᵣₒᵣ (units [mm]) of the corresponding point of the drawing pattern in a target coordinate system D based on the target 220. In addition, the corresponding point of the image for estimation=two-dimensional coordinates X^{I}ₜ₋ₘᵢᵣᵣₒᵣ (units [pixel]) of the corresponding point of the drawing pattern in the image coordinate system I. The three-dimensional coordinates X^{D}ₜ₋ₘᵢᵣᵣₒᵣ and the two-dimensional coordinates X^{I}ₜ₋ₘᵢᵣᵣₒ can be expressed by the following Equations (5) and (6), respectively.

$$\begin{matrix}[ Equation 5 ] & \\ {X}_{t - mirror}^{D} = [ \begin{matrix}{X}_{1} & {X}_{2} & \\ {Y}_{1} & {Y}_{2} & ⋯ \\ 0 & 0 & \end{matrix} ] & ( 5 )\end{matrix}$$

Xi=(x-coordinate[pixel]in the drawing pattern displayed on the target 220 at the corresponding point÷horizontal resolution of the display[pixel]×Physical width of the display [mm])

$$\begin{matrix}[ Equation 6 ] & \\ {X}_{t - mirror}^{I} = [ \begin{matrix}{x}_{1} & {x}_{2} & \\ {y}_{1} & {y}_{2} & ⋯ \\ 1 & 1 & \end{matrix} ] & ( 6 )\end{matrix}$$

Xi=(x-coordinate on the image for estimation at the corresponding point [pixel])

Subsequently, a transform from the target coordinate system D to the camera coordinate system C is estimated by solving the PnP problem from the three-dimensional coordinates X^{D}ₜ₋ₘᵢᵣᵣₒᵣ of the drawing pattern in the target coordinate system D and the two-dimensional coordinates X^{I}ₜ₋ₘᵢᵣᵣₒᵣ (of the mirror image) of the drawing pattern in the image coordinate system I (step S32). Specifically, a rotation matrix R_{D→C} and a translation vector t_{D→C} are estimated as illustrated in the following Equation (7).

[Equation 7]

X^{I}ₜ₋ₘᵢᵣᵣₒᵣ=A[R_{D→C}|t_{D→C}]Xhd t−mirror^{D} (7)

Subsequently, a physical size (wd, hd[mm]) of (the display of) the target 220 is measured, and three-dimensional coordinates X^{C}_{d-mirror} of the mirror image of the target 220 in the camera coordinate system C are determined (step S33). The three-dimensional coordinates X^{C}_{d-mirror} of the mirror image of the target 220 in the camera coordinate system C can be expressed as the following Equation (8).

$$\begin{matrix}[ Equation 8 ] & \\ {X}_{d - mirror}^{C} = {R}_{D \to C} [ \begin{matrix}- {w}_{d} & 0 & 0 & - {w}_{d} \\ 0 & 0 & {h}_{d} & {h}_{d} \\ 0 & 0 & 0 & 0\end{matrix} ] + {t}_{D \to C} & ( 8 )\end{matrix}$$

Subsequently, three-dimensional coordinates X^{M}_{d-mirror} of the mirror image of the target 220 in the mirror coordinate system M are calculated (step S34). The three-dimensional coordinates X^{M}_{d-mirror} of the mirror image of the target 220 in the mirror coordinate system M can be calculated by the following Equation (9).

[Equation 9]

X^{M}_{d-mirror}=R_{R→C}^{T}(X_{d-mirror}^{C}−t_{M→C}) (9)

Subsequently, the three-dimensional coordinates X^{M}_{d-mirror} of the mirror image of the target in the mirror coordinate system M are transformed to three-dimensional coordinates X^{M}_{d} of a real image. Specifically, a z coordinate may be inverted as in the following Equation (10).

$$\begin{matrix}[ Equation 10 ] & \\ {X}_{d}^{M} = {X}_{d - mirror}^{M} ° [ \begin{matrix}1 & 1 & \\ 1 & 1 & ⋯ \\ - 1 & - 1 & \end{matrix} ] & ( 10 )\end{matrix}$$

Finally, three-dimensional coordinates X^{C}_{D} of the target in the camera coordinate system C are calculated (step S36). The three-dimensional coordinates X^{C}_{D} of the target in the camera-coordinate system C are the position of the target 220 with respect to the imaging unit 210 (i.e., the second relative position). The three-dimensional coordinates X^{C}_{D} of the target in camera coordinate system C can be calculated by the following Equation (11).

[Equation 11]

X_{d}^{C}=R_{R→C}X_{d}^{M}+t_{M→C} (11)

### <Supplementary Note>

The example embodiments described above may be further described as, but not limited to, the following Supplementary Notes below.

### (Supplementary Note 1)

A position estimation system described in Supplementary Note 1 is a position estimation system including: an image acquisition unit that obtains an image for estimation including a target that is disposed out of an imaging range of an imaging unit, by imaging a reflecting unit that reflects a light and that is disposed in the imaging range of the imaging unit; a first estimation unit that estimates a first relative position that is a position of the reflecting unit with respect to the imaging unit, on the basis of the image for estimation; and a second estimation unit that estimates a second relative position that is a position of the target with respect to the imaging unit, on the basis of the image for estimation and the first relative position.

### (Supplementary Note 2)

A position estimation system described in Supplementary Note 2 is the position estimation system described in Supplementary Note 1, wherein a marker for detecting the reflecting unit from the image for estimation is attached to the reflecting unit.

### (Supplementary Note 3)

A position estimation system described in Supplementary Note 3 is the position estimation system described in Supplementary Note 2, wherein the marker is in a predetermined shape or in a predetermined color.

### (Supplementary Note 4)

A position estimation system described in Supplementary Note 4 is the position estimation system described in any one of Supplementary Notes 1 to 3, wherein the image for estimation is an image that is captured in a condition in which a drawing pattern that varies depending on a display position is displayed on the target.

### (Supplementary Note 5)

A position estimation system described in Supplementary Note 5 is the position estimation system described in any one of Supplementary Notes 1 to 4, further including a position integration unit that integrates a plurality of the second relative positions estimated from a plurality of the images for estimation to calculate an integrated relative position.

### (Supplementary Note 6)

A position estimation system described in Supplementary Note 6 is the position estimation system described in Supplementary Note 5, wherein the plurality of the images for estimation are images that are captured in a condition in which the first relative position varies.

### (Supplementary Note 7)

A position estimation system described in Supplementary Note 7 is the position estimation system described in any one of Supplementary Notes 1 to 6, wherein the reflecting unit includes glass, metal, acrylic, and polycarbonate.

### (Supplementary Note 8)

A position estimation system described in Supplementary Note 8 is the position estimation system described in any one of Supplementary Notes 1 to 6, wherein the reflecting unit is an eyeball.

### (Supplementary Note 9)

A position estimation method described in Supplementary Note 9 is a position estimation method including: obtaining an image for estimation including a target that is disposed out of an imaging range of an imaging unit, by imaging a reflecting unit that reflects a light and that is disposed in the imaging range of the imaging unit; estimating a first relative position that is a position of the reflecting unit with respect to the imaging unit, on the basis of the image for estimation; and estimating a second relative position that is a position of the target with respect to the imaging unit, on the basis of the image for estimation and the first relative position.

### (Supplementary Note 10)

A computer program described in Supplementary Note 10 is a computer program that operates a computer: to obtain an image for estimation including a target that is disposed out of an imaging range of an imaging unit, by imaging a reflecting unit that reflects a light and that is disposed in the imaging range of the imaging unit; to estimate a first relative position that is a position of the reflecting unit with respect to the imaging unit, on the basis of the image for estimation; and to estimate a second relative position that is a position of the target with respect to the imaging unit, on the basis of the image for estimation and the first relative position.

### (Supplementary Note 11)

A recording medium described in Supplementary Note 11 is a recording medium on which the computer program described in Supplementary Note 10 is recorded.

This disclosure is not limited to the examples described above and is allowed to be changed, if desired, without departing from the essence or spirit of this disclosure which can be read from the claims and the entire specification. A position estimation system, a position estimation method, and a computer programs with such changes are also intended to be within the technical scope of this disclosure.

### DESCRIPTION OF REFERENCE CODES

10 Position estimation system
11 Processor
110 Image acquisition unit
120 First estimation unit
130 Second estimation unit
140 Position integration unit
210 Imaging unit
220 Target
230 Reflecting member
300 Marker

What is claimed is:

1. A position estimation system comprising:
at least one memory that is configured to store instructions; and
at least one processor that is configured to execute the instructions to
acquire an image for estimation including a target that is disposed out of an imaging range of an imaging unit, by imaging a reflecting unit that reflects a light and that is disposed in the imaging range of the imaging unit;
estimate a first relative position that is a position of the reflecting unit with respect to the imaging unit, on the basis of the image for estimation; and
estimate a second relative position that is a position of the target with respect to the imaging unit, on the basis of the image for estimation and the first relative position.

2. The position estimation system according to claim 1, wherein a marker for detecting the reflecting unit from the image for estimation is attached to the reflecting unit.

3. The position estimation system according to claim 2, wherein the marker is in a predetermined shape or in a predetermined color.

4. The position estimation system according to claim 1, wherein the image for estimation is an image that is captured in a condition in which a drawing pattern that varies depending on a display position is displayed on the target.

5. The position estimation system according to claim 1, wherein the at least one processor is configured to execute the instructions to integrate a plurality of the second relative positions estimated from a plurality of the images for estimation to calculate an integrated relative position.

6. The position estimation system according to claim 5, wherein the plurality of the images for estimation are images that are captured in a condition in which the first relative position varies.

7. The position estimation system according to claim 1, wherein the reflecting unit includes glass, metal, acrylic, and polycarbonate.

8. The position estimation system according to claim 1, wherein the reflecting unit is an eyeball.

9. A position estimation method comprising:
acquiring an image for estimation including a target that is disposed out of an imaging range of an imaging unit, by imaging a reflecting unit that reflects a light and that is disposed in the imaging range of the imaging unit;
estimating a first relative position that is a position of the reflecting unit with respect to the imaging unit, on the basis of the image for estimation; and
estimating a second relative position that is a position of the target with respect to the imaging unit, on the basis of the image for estimation and the first relative position.

10. A non-transitory recording medium on which a computer program that allows computer to execute a position estimation method is recorded, the position estimation method including:
acquiring an image for estimation including a target that is disposed out of an imaging range of an imaging unit, by imaging a reflecting unit that reflects a light and that is disposed in the imaging range of the imaging unit;
estimating a first relative position that is a position of the reflecting unit with respect to the imaging unit, on the basis of the image for estimation; and
estimating a second relative position that is a position of the target with respect to the imaging unit, on the basis of the image for estimation and the first relative position.

11. The position estimation system according to claim 1, wherein the at least one processor is configured to execute the instructions to correction a distortion in the image for estimation based on a shape of the marker in the image for estimation.

12. The position estimation system according to claim 1, wherein the first relative position is estimated based on a size of the reflecting unit and a size of the reflecting unit in the image for estimation.

13. The position estimation system according to claim 4, wherein the second relative position is estimated based on the first relative position and a size of the drawing pattern on the target and a size of the drawing pattern in the image for estimation.

14. The position estimation system according to claim 4, wherein the at least one processor is configured to execute the instructions to estimate a position of the drawing pattern in the reflecting unit based on the drawing pattern on the target and the drawing pattern in the image for estimation that is captured in a horizontally inverted condition.
